(19) United States
(12) Patent Application Publication
(10) Pub. No.: US 2026/0024361 A1
(43) Pub. Date: Jan. 22, 2026

(54) APPARATUS FOR DETECTING CARBIDE MORPHOLOGY IN STEEL MATERIAL, METHOD FOR DETECTING CARBIDE MORPHOLOGY IN STEEL MATERIAL, AND PROGRAM FOR DETECTING CARBIDE MORPHOLOGY IN STEEL MATERIAL

(71) Applicants: NHK SPRING CO., LTD., Yokohama-shi (JP); NATIONAL UNIVERSITY CORPORATION TOKAI NATIONAL HIGHER EDUCATION AND RESEARCH SYSTEM, Nagoya (JP)

(72) Inventors: Shintaro KUMAI, Yokohama-shi (JP); Keita TAKAHASHI, Yokohama-shi (JP); Kosuke ONUMA, Yokohama-shi (JP); Yoshitaka ADACHI, Nagoya-shi (JP)

(21) Appl. No.: 19/345,452

(22) Filed: Sep. 30, 2025

Related U.S. Application Data
(63) Continuation of application No. PCT/JP2024/012601, filed on Mar. 28, 2024.

(30) Foreign Application Priority Data
Mar. 31, 2023 (JP) 2023-058438

(51) Int. Cl. G06V 20/69; G06V 10/28; G06V 10/422; G06V 10/88

(52) U.S. Cl. CPC G06V 20/698; G06V 10/28; G06V 10/422; G06V 10/88; G06V 20/695

(57) ABSTRACT

There are provided a detection apparatus capable of properly digitizing the morphology of carbide in steel, a detection method capable of properly digitizing the morphology of carbide in steel, or a detection program capable of properly digitizing the morphology of carbide in steel. An apparatus for detecting a carbide morphology according to an embodiment of the present invention includes an identification unit for identifying a cross-sectional area of a crystal grain constituting a steel material in a microscope image of the steel material, an extraction unit for extracting image data of the cross-sectional area of the crystal grain from the microscope image based on the identified cross-sectional area of the crystal grain, and a data conversion unit for binarizing the extracted image data.

### CROSS-REFERENCE TO RELATED APPLICATIONS

This application is a Continuation of International Patent Application No. PCT/JP2024/012601, filed on Mar. 28, 2024, which claims the benefit of priority to Japanese Patent Application No. 2023-058438, filed on Mar. 31, 2023, the entire contents of which are incorporated herein by reference.

### FIELD

The present invention relates to an apparatus for detecting a carbide morphology of a steel material. Alternatively, the present invention relates to a method for detecting a carbide morphology of a steel material. Alternatively, the present invention relates to a program for detecting a carbide morphology of a steel material.

### BACKGROUND

As an index for evaluating properties of a steel material, carbide morphology is used. For example, Japanese Laid-Open Patent Publication No. 2007-063626 describes a method for manufacturing a steel member for bearings with excellent fatigue properties by heating a steel material having spheroidized carbides with an average aspect ratio of 3 or less as a carbide morphology in the structure at an average heating rate of 0.5° C./s or more from Ac₃ point −10° C. to Ac₃ point, at Acs point or more and Ac₃ point +130° C. or less, with a holding time at Ac₃ point or less of 500 seconds or less, and then quenching the steel material.

Generally, a carbide morphology in a steel material is evaluated by exposing a structure of the steel material by etching, and observing using a scanning-electron microscope (SEM). However, on a surface of the steel material with its structure exposed, various structures including the surfaces of crystal grains and crystal grain boundaries of crystal grains can be observed in addition to the internal structure of crystal grains in which the carbide morphology can be observed. Therefore, the carbide morphology in the steel material became an evaluation based on the observer's experience, and was not provided as objective digitized data.

### SUMMARY

In order to evaluate the properties of the steel material based on the carbide morphology in the steel material, it is required to acquire the carbide morphology in the steel material as digitized data. However, since various structures are observed on the surface of the steel material with its structure exposed, it is difficult to properly digitize the carbide morphology in steel materials by simply binarizing SEM images.

An object of an embodiment of the present invention is to provide a detection apparatus capable of accurately converting a carbide morphology in a steel material into digital data. Alternatively, an object of an embodiment of the present invention is to provide a detection method capable of accurately converting a carbide morphology in a steel material into digital data. Alternatively, an object of an embodiment of the present invention is to provide a detection program capable of accurately converting a carbide morphology in a steel material into digital data.

An apparatus for detecting a carbide morphology according to an embodiment of the present invention includes an identification unit for identifying a cross-sectional area of a crystal grain constituting a steel material from a microscope image of the steel material, an extraction unit for extracting image data of the cross-sectional area of the crystal grain from the microscope image based on the identified cross-sectional area of the crystal grain, and a data conversion unit for binarizing the extracted image data.

An apparatus for detecting a carbide morphology according to an embodiment of the present invention includes a data conversion unit for binarizing image data of a microscope image of a steel material, an identification unit for identifying a cross-sectional area of a crystal grain constituting the steel material from the binarized image data, and an extraction unit for extracting image data of the cross-sectional area of the crystal grain from the binarized image data based on the identified cross-sectional area of the crystal grain.

The identification unit may include a mask data generation unit for producing mask data from the microscope image of the steel material or the binarized image data, the mask data generation unit may set a portion in the microscope image or the binarized image data having a luminance value equal to or less than a first predetermined value as a portion to be masked to generate the mask data, and the identification unit may identify a cross-sectional area of a crystal grain constituting the steel material based on the mask data.

The identification unit may include a machine learning unit that trains a machine learning model using a plurality of microscopic images of the steel material for learning or a plurality of binarized image data for learning, and the identification unit may input the microscope image of the steel material or the binarized image data to the trained machine learning model to identify the cross-sectional area of the crystal grain constituting the steel material.

The extraction unit may extract image data of the cross-sectional area of the crystal grain from the microscope image or binarized image data.

The data conversion unit may binarize the image data of the cross-sectional area in the image data of the cross-sectional area of the crystal grain or the microscope image based on a second predetermined value.

A method for detecting a carbide morphology according to an embodiment of the present invention includes using an apparatus for detecting carbide morphology including an identification unit, an extraction unit, and a data conversion unit, identifying a cross-sectional area of a crystal grain constituting a steel material in a microscope image of the steel material by the identification unit, extracting image data of the cross-sectional area of the crystal grain from the microscope image based on the identified cross-sectional area of the crystal grain by the extraction unit, and binarizing the extracted image data by the data conversion unit to determine a structure of a carbide.

A method for detecting a carbide morphology according to an embodiment of the present invention includes using an apparatus for detecting carbide morphology including an identification unit, an extraction unit, and a data conversion unit, binarizing image data of a microscope image of a steel material by the data conversion unit, identifying a cross-sectional area of a crystal grain constituting the steel material in the binarized image data by the identification unit, and extracting image data of the cross-sectional area of the crystal grain from the binarized image data based on the identified cross-sectional area of the crystal grain by the extraction unit to determine a structure of a carbide.

The identification unit may include a mask data generation unit, wherein the mask data generation unit may set a portion in the microscope image or the binarized image data having a luminance value equal to or less than a first predetermined value as a portion to be masked to generate mask data, and the identification unit may identify the cross-sectional area of the crystal grain constituting the steel material based on the mask data.

The identification unit may include a machine learning unit, wherein the machine learning unit may train a machine learning model using a plurality of microscopic images of the steel material for learning or a plurality of binarized image data for learning, and the identification unit may input the microscope image of the steel material or the binarized image data to the trained machine learning model to identify a cross-sectional area of the crystal grain constituting the steel material.

The extraction unit may extract image data of the cross-sectional area of the crystal grains from the microscope image or the binarized image data.

The data conversion unit may binarize the image data of the cross-sectional area in the image data of the cross-sectional area of the crystal grain or the microscope image based on a second predetermined value.

A program for detecting a carbide morphology according to an embodiment of the present invention includes causing a computer to identify a cross-sectional area of a crystal grain constituting a steel material in a microscope image of a steel material, causing the computer to extract image data of the cross-sectional area from the microscope image based on the identified cross-sectional area of the crystal grain, and causing the computer to binarize the extracted image data to determine a structure of the carbide.

A program for detecting a carbide morphology according to an embodiment of the present invention includes causing a computer to binarize image data of a microscope image of a steel material, causing the computer to identify a cross-sectional area of a crystal grain constituting the steel material in the binarized image data, and causing the computer to extract image data of the cross-sectional area from the binarized image data based on the identified cross-sectional area of the crystal grain to determine a structure of the carbide.

The program may cause the computer to generate mask data from the microscope image or the binarized image data of the steel material, the program may cause the computer to set a portion in the microscope image or the binarized image data having a luminance value equal to or less than a first predetermined value as a portion to be masked to generate the mask data, and the program may cause the computer to identify the cross-sectional area of the crystal grain constituting the steel material based on the mask data.

The program may cause the computer to train the machine learning model using a plurality of microscope images of the steel material for learning or a plurality of binary image data for learning, and the program may cause the computer to input the microscope image of the steel material or the binarized image data to the trained machine learning model to identify the cross-sectional area of the crystal grain constituting the steel material.

The program may cause the computer to extract image data of the cross-sectional area of the crystal grain from the microscope image or the binarized image data.

The program may cause the computer to binarize the image data of the cross-sectional area based on a second predetermined value in the image data or the microscope image of the cross-sectional area of the crystal grain.

### BRIEF DESCRIPTION OF DRAWINGS

FIG. 1A is a block diagram showing an apparatus for detecting a carbide morphology 100 according to the present invention.

FIG. 1B is a block diagram showing an apparatus for detecting a carbide morphology 100A according to an embodiment of the present invention.

FIG. 2A is a SEM image of a surface of a steel material in which a structure of the steel material has been exposed by etching.

In FIG. 2B, the left diagram is an enlarged view of region A, and the right diagram is a binarized view of region A shown in the left diagram.

In FIG. 2C, the left diagram is an enlarged view of region B, and the right diagram is a binarized view of region B shown in the left diagram.

FIG. 3A is a SEM image of a surface of a steel material in which a structure of a steel material has been exposed by etching of an example of the present invention.

FIG. 3B is a diagram showing mask data of an example of the present invention.

FIG. 3C is a diagram of extracting a cross-sectional area of a crystal grain of an example of the present invention.

FIG. 4 is a flow diagram of a method for detecting a carbide morphology according to an embodiment of the present invention.

FIG. 5 is a flow diagram of a method for detecting a carbide morphology according to an embodiment of the present invention.

FIG. 6 is a flow diagram of a method for detecting a carbide morphology according to an embodiment of the present invention.

FIG. 7 is a flow diagram of a method for detecting a carbide morphology according to an embodiment of the present invention.

FIG. 8 is a flow diagram of a method for detecting a carbide morphology according to an embodiment of the present invention.

FIG. 9 is a flow diagram of a method for detecting a carbide morphology according to an embodiment of the present invention.

FIG. 10 is a flow diagram of a method for detecting a carbide morphology according to an embodiment of the present invention.

FIG. 11 is a flow diagram of a method for detecting a carbide morphology according to an embodiment of the present invention.

FIG. 12 is a flow diagram of a method for detecting a carbide morphology according to an embodiment of the present invention.

FIG. 13 is a flow diagram of a method for detecting a carbide morphology according to an embodiment of the present invention.

FIG. 14 is a flow diagram of a method for detecting a carbide morphology according to an embodiment of the present invention.

FIG. 15 is a flow diagram of a method for detecting a carbide morphology according to an embodiment of the present invention.

FIG. 16 is a flow diagram of a method for detecting a carbide morphology according to an embodiment of the present invention.

FIG. 17 is a flow diagram of a method for detecting a carbide morphology according to an embodiment of the present invention.

FIG. 18 is a flow diagram of a method for detecting a carbide morphology according to an embodiment of the present invention.

FIG. 19 is a flow diagram of a method for detecting a carbide morphology according to an embodiment of the present invention.

### DESCRIPTION OF EMBODIMENTS

Hereinafter, an embodiment of the present invention will be described with reference to the drawings. Embodiments shown below are examples of the embodiment of the present invention, and the present invention is not limited to these embodiments.

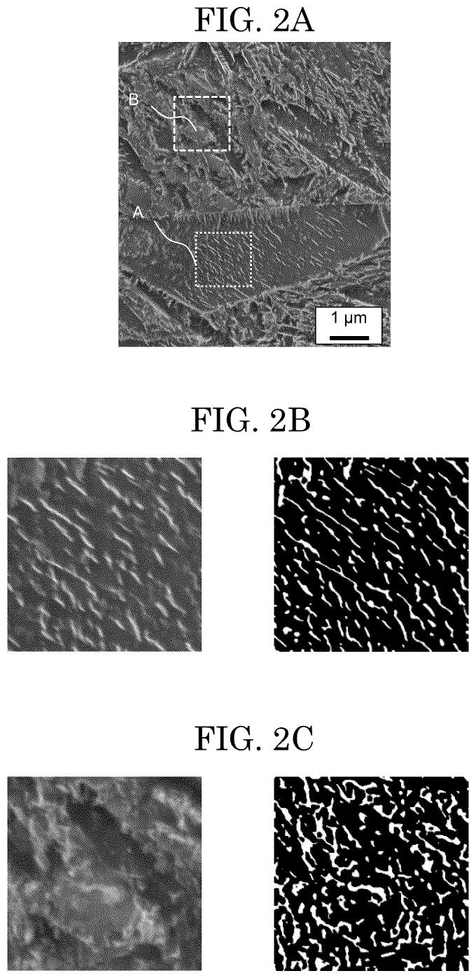

As described above, in a SEM image of a surface of a steel material with its structure exposed, various structures are observed. Now, reference is made to FIG. 2A. FIG. 2A is a SEM image of the surface of the steel material in which the structure of the steel material has been exposed by etching. In FIG. 2A, a region A shows an inner construction of a crystal grain. On the other hand, a region B shows a state in which a structure containing surfaces of crystal grains and crystal grain boundaries of crystal grains are mixed. The left diagram of FIG. 2B is an enlarged view of the region A, the left diagram of FIG. 2C is an enlarged view of the region B. As is clear from FIG. 2A and the left diagram of FIG. 2B, in the region A showing the inner structure of the crystal grains, white linear crystal grains are observed. This white linear crystal grains show the carbides present inside the crystal grains. On the other hand, as is clear from FIG. 2A and the left diagram of FIG. 2C, in the region B, although white linear crystal grains are observed, it is difficult to distinguish from surrounding structures.

The right diagram of FIG. 2B shows the binarization of the region A shown on the left diagram of FIG. 2B. Comparing the left diagram of FIG. 2B and the right diagram of FIG. 2B, in the right diagram of FIG. 2B, it is clear that the binarized carbide properly reflects the shapes of the left diagram of FIG. 2B. From these, it is understood that only information of carbides is appropriately extracted by binarizing the structure of the carbide, and binarized information of carbides can be used as an index for evaluating the properties of a steel material.

The right diagram of FIG. 2C shows the result of binarization of the region B shown on the left diagram of FIG. 2C. Comparing the right diagram of FIG. 2B showing the binarized carbides with the right view of FIG. 2C showing the binarized region B, the structure shown in white is clearly different, and it is understood that information such as the surfaces of the crystal grains and the crystal grain boundaries of the crystal grains are included as noise in the region B.

In order to utilize the structure of the carbide as an index for evaluating the properties of a steel material, it is necessary to properly select a region inside the crystal grain which does not contain noise and to binarize the image data of that region. In the following embodiments, an apparatus, a method, and a program for executing the method for selecting an appropriate region from a SEM image, and acquiring the structure of the carbides as binarized data will be described.

### Apparatus for Detecting Carbide Morphology

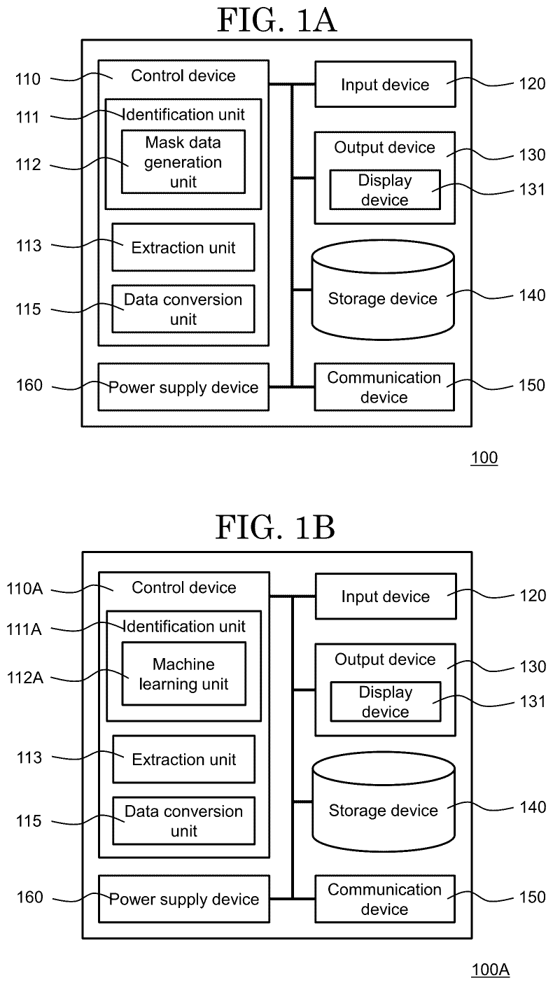

FIG. 1A is a block diagram showing an apparatus 100 for detecting a carbide morphology according to the present invention. The apparatus 100 for detecting the carbide morphology includes, for example, a control device 110, an input device 120, an output device 130, a storage device 140, a communication device 150, and a power supply device 160. Further, in an embodiment, the apparatus 100 for detecting the carbide morphology further includes, for example, an identification unit 111, an extraction unit 113, and a data conversion unit 115.

The control device 110 is composed of a known central processing unit (CPU), an operating system (OS), and a control program or module for controlling the apparatus 100 for detecting the carbide morphology. Alternatively, the control device 110 may be provided as one program that includes an OS and a control program or module. The control program or module constituting the control device 110 is stored in the storage device 140, and is executed in the CPU.

In FIG. 1A, as an embodiment, although a configuration in which the control device 110 includes the identification unit 111, the extraction unit 113, and the data conversion unit 115 is shown, the identification unit 111, the extraction unit 113, and the data conversion unit 115 may not be included in the control device 110, and may be arranged together with the control device 110.

The identification unit 111 is composed of a program or module for identifying a cross-sectional area of crystal grains constituting a steel material from a SEM image of the steel material. The program or module comprising the identification unit 111 is stored in the storage device 140, and is executed in the CPU. In an embodiment, the identification unit 111 includes a mask data generation unit 112. The mask data generation unit 112 is a program or module for generating mask data from the SEM image of the steel material, is stored in the storage device 140, and is executed in the CPU. In FIG. 1A, although the identification unit 111 includes the mask data generation unit 112, the mask data generation unit 112 may not be included in the identification unit 111, and may be arranged together with the identification unit 111. In the present embodiment, the identification unit 111 is able to identify a cross-sectional area of the crystal grains constituting the steel material based on the mask data generated by the mask data generation unit 112.

In this specification, the “masking data” is data indicating a region to be excluded from the SEM image of the steel material in order to identify the cross-sectional area of the crystal grains constituting the steel material corresponding to the region A described above. The region excluded from the SEM image of the steel material is a region including a structure that becomes noise of a surface of the crystal grains and crystal grain boundaries of the crystal grains corresponding to the region B described above and the like. In an embodiment, the mask data generation unit 112 sets a portion having a luminance value equal to or less than a predetermined value (hereinafter, also referred to as a first predetermined value) as a portion to be masked in the SEM image, and generates the mask data. In an embodiment, the first predetermined value may be a luminance value set in advance from observation of the SEM image of the steel material, and may be a luminance value set by a user for the SEM image of the actual steel material to be processed by the mask data generation unit 112 and confirmed by the user on a display device 131. In an embodiment, an average value of the luminance of the pixel of interest and the luminance of surrounding pixels may be set as the first predetermined value (adaptive binarization).

The extraction unit 113 is a program or module for extracting the image data of the cross-sectional area of the crystal grains from the SEM image based on the cross-sectional area of the crystal grains identified by the identification unit 111. The program or module comprising the extraction unit 113 is stored in the storage device 140, and is executed in the CPU. In an embodiment, the extraction unit 113 extracts the image data of the cross-sectional area of the crystal grains from the SEM image based on the cross-sectional area of the crystal grains constituting the steel material identified by the identification unit 111. In other words, the extraction unit 113 extracts the image data of the cross-sectional area of the crystal grains by subtracting the area including the structure which becomes noise from the SEM image based on the mask data generated by the mask data generation unit 112.

The data conversion unit 115 is constituted by a program or a module for binarizing the image data extracted by the extraction unit 113. The program or module comprising the data conversion unit 115 is stored in the storage device 140, and is executed in the CPU. In an embodiment, the data conversion unit 115 binarizes the image data of the cross-sectional area of the crystal grains in the image data of the cross-sectional area of the crystal grains, based on a predetermined value (hereinafter, also referred to as a second predetermined value). More specifically, the luminance value of the portion having a luminance of the second predetermined value or more (or larger than the second predetermined value) in the image data is converted to 1, and the luminance value of the portion having a luminance less than the second predetermined value (or the second predetermined value or less) is converted to 0. By such a process, the data conversion unit 115 can identify a portion having the luminance value 1 as a structure of a carbide. In addition, the second predetermined value may be a luminance value set in advance from the observation of the SEM image of the steel material, and may be a luminance value set by the user in the SEM image of the actual steel material to be processed by the data conversion unit 115 and the SEM image is confirmed by the user on the display device 131. In an embodiment, an average value of the luminance of the pixel of interest and the luminance of the surrounding pixels may be set as the second predetermined value (adaptive binarization).

The input device 120 is a device for operating the apparatus 100 for detecting the carbide morphology, and it is possible to use a known input device such as a keyboard, a mouse, and a touch panel disposed on a display device (for example, a liquid crystal display or an organic EL display). In an embodiment, the input device 120 may include a scanning electron microscope for acquiring the SEM image as described above. Alternatively, the input device 120 may include a drive or a reader, such as a CD drive, a DVD drive, or a memory card reader, to which a media stored with the image data of the SEM image can be connected.

The output device 130 includes the display device 131 for displaying various images generated by the apparatus 100 for detecting the carbide morphology. The display device 131 can display, for example, the SEM image, the mask data, the cross-sectional area of the crystal grains constituting the steel material, the binarized image data, and the like. As the display device 131, for example, although a liquid crystal display or an organic EL display or the like can be used, the present invention is not limited thereto. The output device 130 may also include a printer that prints an image displayed by the display device 131.

The storage device 140 is a device that stores one or more programs or modules selected from an operating system (OS) and a control program or module that constitute the control device 110, a program or module that constitutes the identification unit 111, a program or module that constitutes the mask data generation unit 112, a program or module that constitutes the extraction unit 113, and a program or module that constitutes the data conversion unit 115. The storage device 140 may include, for example, a known main storage device, such as a random access memory (RAM), or a known auxiliary storage device, such as a read only memory (ROM), a hard disk, or a solid state drive (SSD), and a memory card. In addition, the auxiliary storage device may be arranged outside the apparatus 100 for detecting the carbide morphology, and may be arranged in a server or a network drive which can communicate through the communication device 150.

The communication device 150 is a known wired or wireless communication device that is controllable by the control device 110. The communication device 150 may be connected to a communication network such as a local area network (LAN), a wide area network (WAN), and the Internet. The communication device 150 may be, for example, a communication device conforming to a radio communication standard such as Wi-Fi (registered trademark) (a communication method using IEEE 802.11 standard) or Bluetooth (registered trademark). The communication device 150 may perform data communication with the server and the network drive arranged outside of the apparatus 100 for detecting the carbide morphology. In an embodiment, the communication device 150 may include a serial bus, such as a universal serial bus (USB) and a PCI Express and serial ATA (SATA), and a parallel bus, such as a small computer system interface (SCSI) and peripheral component interconnect (PCI).

The power supply device 160 is a device for supplying power from the outside to each device of the apparatus 100 for detecting the carbide morphology, but is not particularly limited.

### Modified Example of Apparatus for Detecting Carbide Morphology

In the above embodiment, an example in which the identification unit identifies the cross-sectional area of the crystal grains constituting the steel material from the scanning electron microscope image of the steel material, the extraction unit extracts the image data of the cross-sectional area of the crystal grains from the scanning electron microscope image based on the cross-sectional area of the identified crystal grains, and the data conversion unit binarizes the extracted image data to determine the structure of the carbide has been described. However, in the apparatus for detecting the carbide morphology according to the present invention, it is also possible to identify the cross-sectional area of the crystal grains constituting the steel material after binarizing the scanning electron microscope image of the steel material.

Ther data conversion unit 115 may be configured with a program or module for binarizing the SEM image of the steel material. The data conversion unit 115 binarizes the SEM image of the steel material, based on a predetermined value (hereinafter, also referred to as a second predetermined value). More specifically, the data conversion unit 115 converts a luminance value of a portion having a luminance of the second predetermined value or more (or greater than the second predetermined value) in the SEM image of the steel material to 1, and converts a luminance value of a portion having a luminance less than the second predetermined value (or the second predetermined value or less) to 0. By such a process, the data conversion unit 115 can determine the portion having the luminance value 1 as a possible structure that may be a carbide. In addition, the second predetermined value may be a luminance value set in advance from the observation of the SEM image of the steel material, and may be a luminance value set by the user in the SEM image of the actual steel material that is processed by the data conversion unit 115 and the SEM image is confirmed by the user on the display device 131. In an embodiment, an average value of the luminance of the pixel of interest and the luminance of the surrounding pixels may be set as the second predetermined value (adaptive binarization).

In an embodiment, the identification unit 111 is configured with a program or module for identifying the cross-sectional area of the crystal grains constituting the steel material from the image data binarized by the data conversion unit 115. In an embodiment, the mask data generation unit 112 is a program or module for generating mask data from the binarized image data. In the present embodiment, the identification unit 111 can identify the cross-sectional area of the crystal grains constituting the steel material based on the mask data generated by the mask data generation unit 112.

The extraction unit 113 is configured with a program or a module for extracting image data of the cross-sectional area of the binarized crystal grains based on the cross-sectional area of the crystal grains identified by the identification unit 111. In an embodiment, the extraction unit 113 extracts the image data of the cross-sectional area of the crystal grains from the binarized image data, based on the cross-sectional area of the crystal grains constituting the steel material identified by the identification unit 111. In other words, the extraction unit 113 extracts the image data of the cross-sectional area of the crystal grains by subtracting the area including the structure that becomes noise from the binarized image data based on the mask data generated by the mask data generation unit 112. By such a process, the extraction unit 113 can determine the extracted region as a region in which a structure of a carbide is present.

### Apparatus for Detecting Carbide Morphology Using Machine Learning

In the embodiment described above, an exemplary method of extracting the image data of the cross-sectional area of the crystal grains from the SEM image based on the mask data generated by the mask data generation unit 112 has been described. However, an apparatus for detecting carbide morphology according to the present invention can be configured to use machine learning to extract the image data of the cross-sectional area of the crystal grains from the SEM image.

FIG. 1B is a block diagram showing an apparatus 100A for detecting a carbide morphology according to an embodiment of the present invention. The apparatus 100A for detecting the carbide morphology includes, for example, a control device 110A, the input device 120, the output device 130, the storage device 140, the communication device 150, and the power supply device 160. Further, in the present embodiment, the apparatus 100A for detecting the carbide morphology further includes, for example, an identification unit 111A, the extraction unit 113, and the data conversion unit 115. In addition, in the apparatus 100A for detecting the carbide morphology, since configurations of the input device 120, the output device 130, the storage device 140, the communication device 150, the power supply device 160, the extraction unit 113, and the data conversion unit 115 are the same as the configuration described in relation to the apparatus 100 for detecting the carbide morphology respectively, a detailed description thereof will be omitted.

The control device 110A is composed of a known central processor (CPU), an operating system (OS), and a control program or module for controlling the apparatus 100A for detecting the carbide morphology. Alternatively, the control device 110A may be provided as one program including the OS and the control program or module. The control program or module constituting the control device 110A is stored in the storage device 140, and is executed in the CPU.

In FIG. 1B, as an embodiment, although a configuration in which the control device 110A includes the identification unit 111A, the extraction unit 113, and the data conversion unit 115 is shown, the identification unit 111A, the extraction unit 113, and the data conversion unit 115 may not be included in the control device 110, and may be arranged together with the control device 110Acontrol device.

The identification unit 111A is composed of a program or module for identifying the cross-sectional area of the crystal grains constituting the steel material from a SEM image of the steel material. The program or module comprising the identification unit 111A is stored in the storage device 140, and is executed in the CPU. In an embodiment, the identification unit 111A includes a machine learning unit 112A. The machine learning unit 112A is a program or module for training a machine learning model and is stored in the storage device 140, and executed in the CPU. In FIG. 1B, although the identification unit 111A includes the machine learning unit 112A, the machine learning unit 112A may not be included in the identification unit 111A, and the machine learning unit 112A may be provided together with the identification unit 111A. In the present embodiment, the identification unit 111A can identify the cross-sectional area of the crystal grains constituting the steel material based on the machine learning model that the machine learning unit 112A was made to learn.

The machine learning unit 112A trains the machine learning model using a plurality of SEM images of steel materials for learning. The machine learning performed by the machine learning unit 112A may be either supervised learning, unsupervised learning, or reinforcement learning, however, in an embodiment, the machine learning model may be trained by supervised learning that provides cross-sectional areas of the crystal grains constituting the steel material in the SEM image used for learning.

In an embodiment, the machine learning unit 112A may perform deep learning using a neural network. In an embodiment, the machine learning unit 112A may also perform machine learning to identify the cross-sectional areas of the crystal grains constituting the steel material using a Trainable Weka Segmentation (TWS) method. For example, features are extracted from the SEM images using a plurality of filters, and feature vectors are created for each pixel. Using the created feature vectors, a decision tree is trained as a machine learning model to create a classifier based on the random forest method. The random forest method randomly selects a plurality of feature vectors among a plurality of feature vectors obtained by filtering, and identifies them based on the weighted average probability obtained by a plurality of decision trees. The constructed classifier is applied to the SEM images to perform classification by classes.

In the apparatus 100A for detecting the carbide morphology, the identification unit 111A can automatically identify the cross-sectional area of the crystal grains constituting the steel material by utilizing the machine learning model trained by the machine learning unit 112A.

### Modified Example of Apparatus for Detecting Carbide Morphology Using Machine Learning

As described above, in the apparatus for detecting the carbide morphology according to the present invention, it is also possible to identify the cross-sectional area of the crystal grains constituting the steel material after binarizing the scanning electron microscope image of the steel material.

That is, the identification unit 111A may be configured with a program or module for identifying the cross-sectional area of the crystal grains constituting the steel material from the image data binarized by the data converter 115. In an embodiment, the machine learning unit 112A trains the machine learning model using the image data obtained by binarizing the SEM image of a plurality of steel materials for learning by the data conversion unit 115. The machine learning performed by the machine learning unit 112A may be either supervised learning, unsupervised learning, or reinforcement learning, however, in an embodiment, the machine learning model may be trained by supervised learning that provides cross-sectional areas of the crystal grains constituting the steel material in the binarized image data used for learning.

In an embodiment, the machine learning unit 112A extracts features from binarized image data using a plurality of filters and creates feature vectors for each pixel. Using the created feature vectors, a decision tree may be trained as a machine learning model to create a classifier based on the random forest method. The created classifiers can be applied to binary image data to perform classification by class.

In the apparatus 100A for detecting the carbide morphology, the identification unit 111A can automatically identify the cross-sectional area of the crystal grains constituting the steel material by utilizing the machine learning model trained by the machine learning unit 112A.

### Method for Detecting Carbide Morphology

A method for detecting a carbide morphology using the apparatus 100 for detecting the carbide morphology according to the present invention described above will be explained.

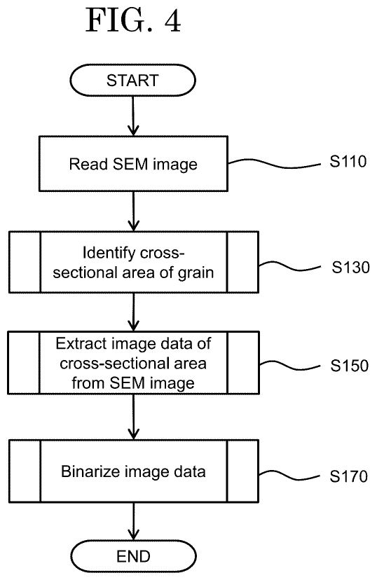

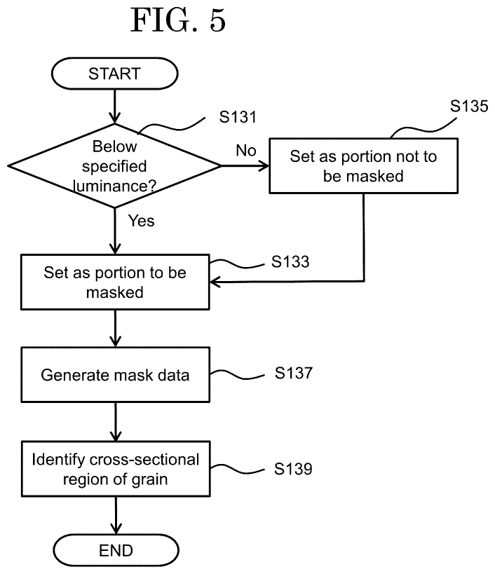

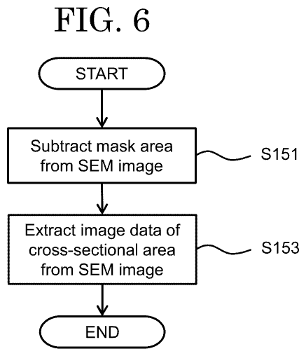

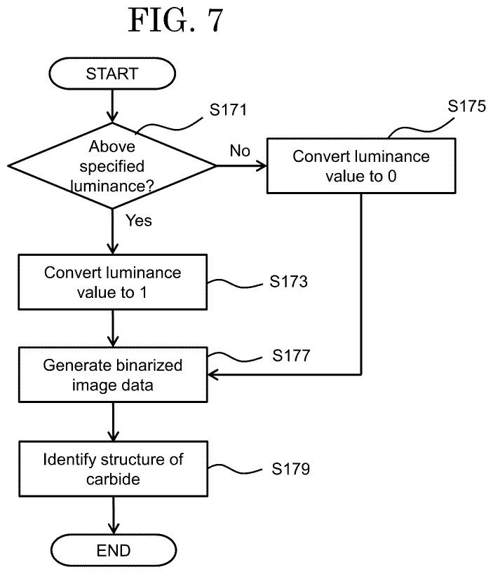

FIG. 4 to FIG. 7 are flow diagrams of a method for detecting a carbide morphology according to an embodiment. The identification unit 111 reads the SEM image of the steel material (S110). The SEM image of the steel material may be read through the input device 120, and the identification unit 111 may read the SEM image stored in the storage device 140. Further, the identification unit 111 may read the SEM image stored in the server or the network drive via a network connected to the communication device 150.

The identification unit 111 identifies the cross-sectional area of the crystal grains constituting the steel material from the read SEM image of the steel material (S130). In an embodiment, the mask data generation unit 112 determines whether or not the pixels constituting the SEM image have a luminance value equal to or less than the first predetermined value (S131). The mask data generation unit 112 sets the pixel having the luminance value equal to or less than the first predetermined value to a portion to be masked (S133). In addition, the mask data generation unit 112 sets the pixel having a luminance value higher than the first predetermined value to the portion not to be masked (S135). The portions thus set are synthesized, and the mask data generation unit 112 generates mask data from the SEM image (S137). The identification unit 111 can identify the cross-sectional area of the crystal grains constituting the steel material based on the mask data (S139).

The extraction unit 113 extracts the image data of the cross-sectional area of the crystal grains from the SEM image based on the cross-sectional area of the crystal grains identified by the identification unit 111 (S150). Specifically, the extraction unit 113 subtracts the mask area including the structure that becomes noise from the SEM image based on the mask data generated by the mask data generation unit 112 (S151), and extracts the image data of the cross-sectional area of the crystal grains (S153).

The data conversion unit 115 binarizes the image data extracted by the extraction unit 113 (S170). Specifically, the data conversion unit 115 binarizes the image data of the cross-sectional area of the crystal grains for each extracted pixel constituting the image data of the cross-sectional area of the crystal grains, based on the second predetermined value (S171). More specifically, the data conversion unit 115 converts a luminance value of a portion having a luminance of the second predetermined value or more (or greater than the second predetermined value) in the image data to 1 (S173), and a luminance value of a portion having a luminance less than the second predetermined value (or the second predetermined value or less) to 0 (S175). The portions thus set are synthesized, and the data conversion unit 115 generates image data obtained by binarizing the cross-sectional area of the crystal grains from the image data of the cross-sectional area of the crystal grains (S177). As a result, the data conversion unit 115 can identify the portion having the luminance value 1 as a structure of a carbide. In addition the second predetermined value may be a luminance value set in advance from the observation of the SEM image of the steel material, and may be a luminance value set by the user in the SEM image of the actual steel material that is processed by the data conversion unit 115 and the SEM image is confirmed by the user on the display device 131. In an embodiment, an average value of the luminance of the pixel of interest and the luminance of the surrounding pixels may be set as the second predetermined value (adaptive binarization).

### Modified Example of Method for Detecting Carbide Morphology

In the above embodiment, an example in which the identification unit identifies the cross-sectional area of the crystal grains constituting the steel material from the scanning electron microscope image of the steel material, the extraction unit extracts the image data of the cross-sectional area of the crystal grains from the scanning electron microscope image based on the identified cross-sectional area of the crystal grains, and the data conversion unit binarizes the extracted image data to determine the structure of the carbide has been described. However, in the method for detecting the carbide morphology according to the present invention, it is also possible to identify the cross-sectional area of the crystal grains constituting the steel material after binarizing the scanning electron microscope image of the steel material.

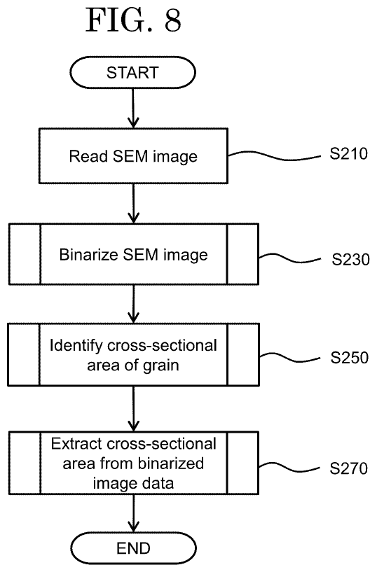

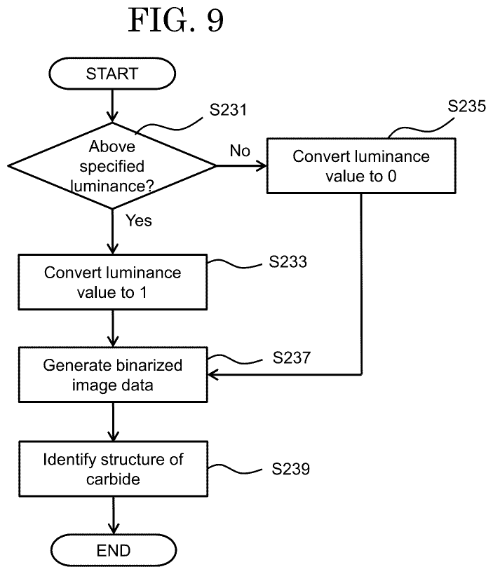

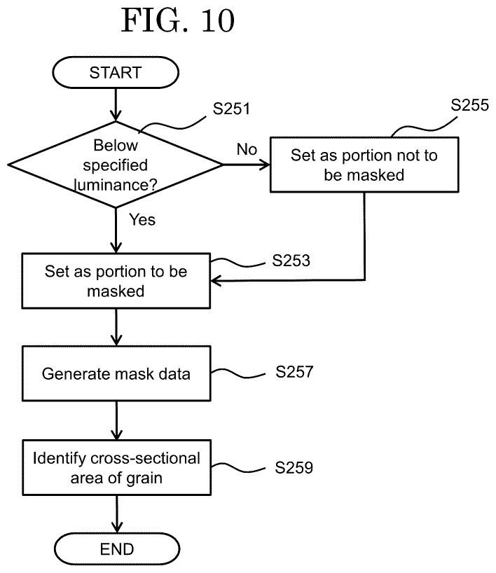

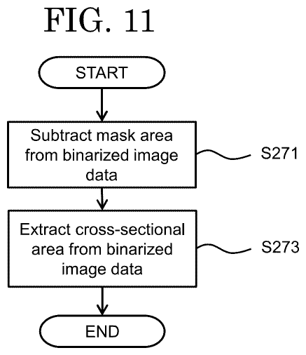

FIG. 8 to FIG. 11 are flow diagrams of a method for detecting a carbide morphology according to an embodiment. The data conversion unit 115 reads the SEM image of the steel material (S210). Since a step of reading the SEM image is the same process as that of S110 described above, a detailed explanation thereof will be omitted. The data conversion unit 115 binarizes the SEM image of the steel material (S230). In the SEM image of the steel material, the data conversion unit 115 binarizes the SEM image of the steel material based on a predetermined value (hereinafter, also referred to as a second predetermined value) (S231). More specifically, a luminance value of a portion having a luminance of the second predetermined value or more (or greater than the second predetermined value) in the SEM image of the steel material is converted to 1 (S233), and a luminance value of a portion having a luminance less than the second predetermined value (or the second predetermined value or less) is converted to 0 (S235). By such a process, the data conversion unit 115 can determine the portion having the luminance value 1 as a structure that may be a carbide (S239). The second predetermined value may be a luminance value set in advance from the observation of the SEM image of the steel material, or may be a luminance value set by a user in the SEM image of the actual steel material that is processed by the data conversion unit 115 and that the SEM image is confirmed by the user on the display device 131. In an embodiment, an average value of the luminance of the pixel of interest and the luminance of the surrounding pixels may be set as the second predetermined value (adaptive binarization).

The identification unit 111 identifies the cross-sectional area of the crystal grains constituting the steel material from the image data binarized by the data conversion unit 115 (S250). In an embodiment, the mask data generation unit 112 determines whether or not the pixels constituting the binarized image data have a luminance value equal to or less than the first predetermined value (S251). The mask data generation unit 112 sets the pixel having the luminance value equal to or less than the first predetermined value to the portion to be masked (S253). In addition, the mask data generation unit 112 sets the pixel having a luminance value higher than the first predetermined value to the portion not to be masked (S255). The portions thus set are synthesized, and the mask data generation unit 112 generates the mask data from the binarized image data (S257). The identification unit 111 can identify the cross-sectional area of the crystal grains constituting the steel material in the binary image data, based on the mask data (S259).

The extraction unit 113 extracts the image data of the cross-sectional area of the crystal grain from the binarized image data on the basis of the cross-sectional area of the crystal grain of the binarized image data identified by the identification unit 111 (S270). Specifically, the extraction unit 113 subtracts a mask area including a structure that becomes noise from the binarized image data based on the mask data generated by the mask data generation unit 112 (S271), and extracts the image data of the cross-sectional area of the crystal grains (S273). As a result, the extraction unit 113 can identify the cross-sectional area of the crystal grains extracted from the binarized image data as a structure of the carbide.

### Method for Detecting Carbide Morphology Using Machine Learning

In the embodiment described above, an exemplary method of extracting the image data of the cross-sectional area of the crystal grains from the SEM image based on the mask data generated by the mask data generation unit 112 has been described. However, the method for detecting the carbide morphology according to the present invention can also be configured to extract the image data of the cross-sectional area of the crystal grains from the SEM image by using machine learning.

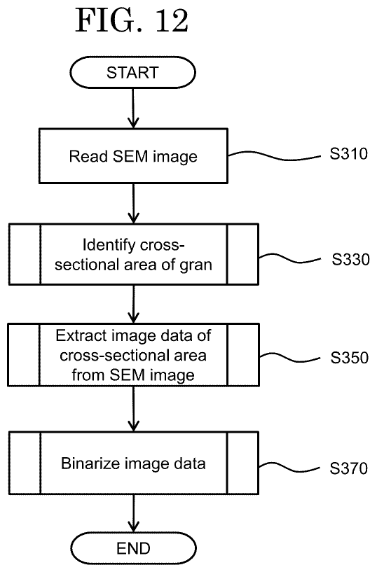

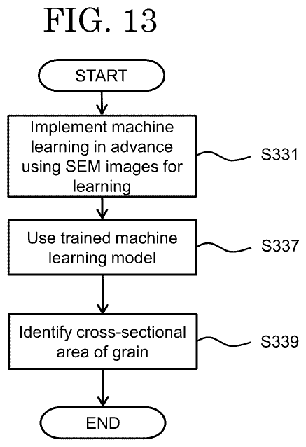

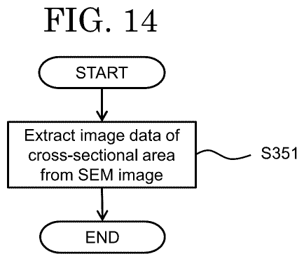

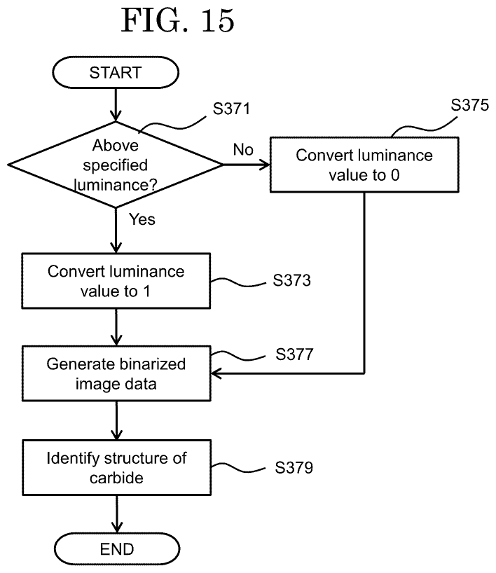

FIG. 12 to FIG. 15 are flow diagrams of a method for detecting a carbide morphology according to an embodiment. The identification unit 111A reads the SEM image of the steel material (S310). Since a step of reading the SEM image is the same process as that of S110 described above, a detailed explanation thereof will be omitted. The identification unit 111A identifies the cross-sectional area of the crystal grains constituting the steel material from the read SEM image of the steel material (S330).

The machine learning unit 112A trains a machine learning model using a plurality of the SEM images of the steel materials for learning (S331). Although the machine learning performed by the machine learning unit 112A may be either supervised learning, unsupervised learning, or reinforcement learning, in an embodiment, the machine learning model may be trained by supervised learning that provides cross-sectional areas of the crystal grains comprising the steel material in the SEM image used for learning.

In an embodiment, the machine learning unit 112A may perform deep learning using a neural network. Further, in an embodiment, the machine learning unit 112A may perform machine learning to identify the cross-sectional area of the crystal grains constituting the steel material using the TWS method. For example, features are extracted from the SEM images using a plurality of filters, and feature vectors are created for each pixel. Using the created feature vectors, the machine learning unit 112A trains a decision tree as a machine learning model and creates a classifier based on the random forest method. The random forest method randomly selects multiple feature vectors among multiple feature vectors obtained by filtering, and identifies them based on a weighted average probability obtained by multiple decision trees. Classification by class is executed by applying the created classifier to the SEM image (S333). Consequently, the machine learning unit 112A identifies the cross-sectional area of the crystal grains constituting the steel material (S335).

The extraction unit 113 extracts the image data of the cross-sectional area of the crystal grains from a SEM image based on the cross-sectional area of the crystal grains identified by the identification unit 111A (S150). Specifically, the extraction unit 113 extracts the image data of the cross-sectional area of the crystal grains based on the cross-sectional area of the crystal grains identified by the identification unit 111A (S351).

The data conversion unit 115 binarizes the image data extracted by the extraction unit 113 (S370). Specifically, the data conversion unit 115 binarizes the image data of the cross-sectional area of the crystal grains for each pixel constituting the image data of the cross-sectional area of the extracted crystal grains, based on the second predetermined value (S371). More specifically, the data conversion unit 115 converts a luminance value of a portion having a luminance of the second predetermined value or more (or greater than the second predetermined value) in the image data to 1 (S373), and converts a luminance value of a portion having a luminance less than the second predetermined value (or the second predetermined value or less) to 0 (S375).

The portions thus set are synthesized, and the data conversion unit 115 generates image data obtained by binarizing the cross-sectional area of the crystal grains from the image data of the cross-sectional area of the crystal grains (S377). As a result, the data conversion unit 115 can identify the portion having the luminance value 1 as a structure of a carbide. The second predetermined value may be a luminance value set in advance from the observation of the SEM image of the steel material, and may be a luminance value set by the user in the actual SEM image of the steel material that is processed by the data conversion unit 115 and that the user confirmed on the display device 131. In an embodiment, an average value of the luminance of the pixel of interest and the luminance of the surrounding pixels may be set as the second predetermined value (adaptive binarization).

### Modified Example of Method for Detecting Carbide Morphology Using Machine Learning

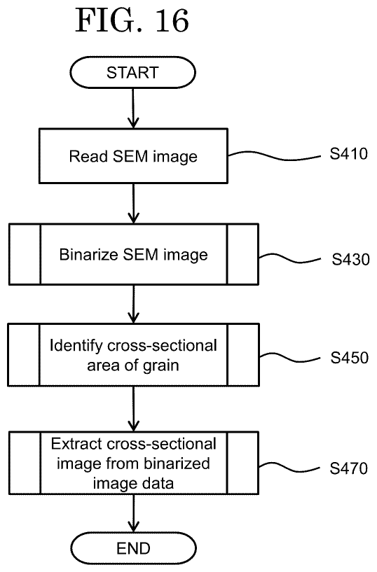

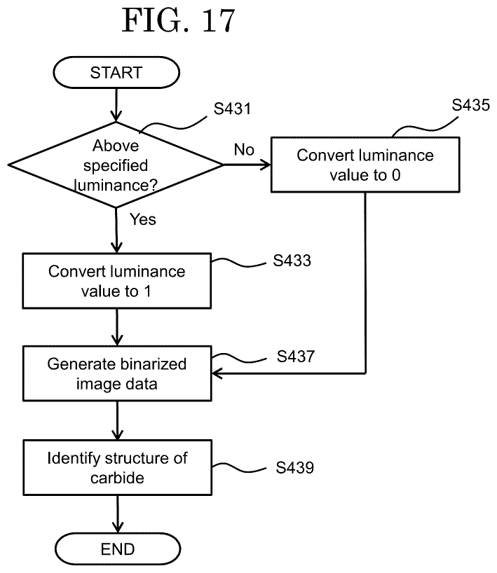

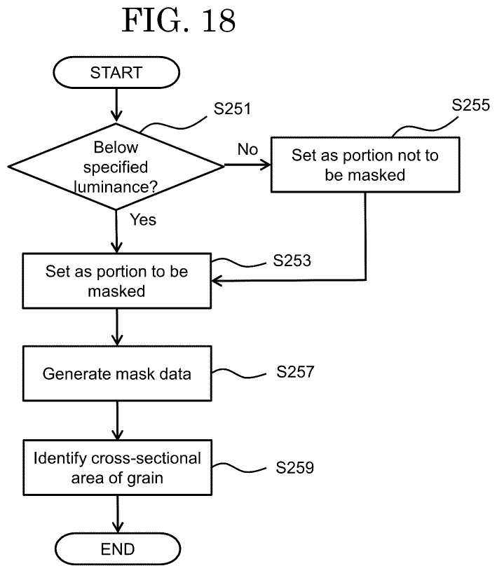

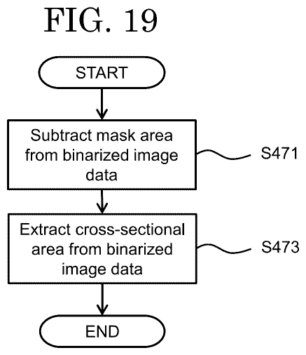

As described above, in the method for detecting the carbide morphology according to the present invention, after binarizing the scanning electron microscope image of the steel material, it is also possible to identify the cross-sectional area of the crystal grains constituting the steel material. FIG. 16 to FIG. 19 are flow diagrams of a method for detecting a carbide morphology according to an embodiment. The data conversion unit 115 reads the SEM image of the steel material (S410). Since a step of reading a SEM image is the same process as that of S110 described above, a detailed explanation thereof will be omitted. The data conversion unit 115 binarizes the SEM image of the steel material (S430). The data conversion unit 115 binarizes the SEM image of the steel material in the SEM image of the steel material, based on a predetermined value (hereinafter, also referred to as a second predetermined value) (S431). More specifically, a luminance value of a portion having a luminance of the second predetermined value or more in the SEM image of the steel material (or greater than the second predetermined value) is converted to 1 (S433), and a luminance value of a portion having a luminance less than the second predetermined value (or the second predetermined value or less) is converted to 0 (S435). By such a process, the data conversion unit 115 can determine the portion having the luminance value 1 as a structure which may be a carbide (S439). In addition, the second predetermined value may be a luminance value set in advance from the observation of the SEM image of the steel material, and may be a luminance value set by the user in the actual SEM image of the steel material that is processed by the data conversion unit 115 and that the user confirmed on the display device 131. In an embodiment, an average value of the luminance of the pixel of interest and the luminance of the surrounding pixels may be set as the second predetermined value (adaptive binarization).

The identification unit 111A identifies the cross-sectional area of the crystal grains constituting the steel material from the image data binarized by the data conversion unit 115 (S430). The machine learning unit 112A trains a machine learning model using a plurality of binarized image data for learning (S431). Although the machine learning performed by the machine learning unit 112A may be either supervised learning, unsupervised learning, or reinforcement learning, in an embodiment, the machine learning model may be trained by supervised learning that provides cross-sectional areas of the crystal grains constituting the steel material in the SEM image used for learning.

In an embodiment, the machine learning unit 112A may perform deep learning using a neural network. In an embodiment, the machine learning unit 112A may also perform machine learning to identify the cross-sectional areas of the crystal grains comprising the steel material using the Trainable Weka Segmentation (TWS) method. For example, features are extracted from the SEM images using a plurality of filters, and feature vectors are created for each pixel. The created feature vector is used to train a decision tree as a machine learning model to create a classifier based on the random forest method. In addition, the random forest method randomly selects multiple feature vectors among multiple feature vectors obtained by filtering, and identifies them based on the weighted average probability obtained by multiple decision trees. By applying the created classifier to binary image data, classifications are executed by class (S433). Consequently, the machine learning unit 112A identifies the cross-sectional area of the crystal grains constituting the steel material in the binarized image data (S435).

The extraction unit 113 extracts the image data of the cross-sectional area of the crystal grains from the binarized image data on the basis of the cross-sectional area of the crystal grains of the binarized image data identified by the identification unit 111A (S370). Specifically, the extraction unit 113 extracts the image data of the cross-sectional area of the crystal grains from the binarized image data based on the cross-sectional area of the crystal grains identified by the discriminator 111A (S351). As a result, the extraction unit 113 can identify the cross-sectional area of the crystal grains extracted from the binarized image data as a structure of a carbide.

### Program for Detecting Carbide Morphology

In an embodiment of the present invention, it is possible to provide a program for performing the method for detecting the carbide morphology described above. Alternatively, in an embodiment, the method can be provided as a recording medium which stores the program. A description is provided with reference to FIG. 4 to FIG. 7.

The program causes the identification unit 111 to read the SEM image of the steel material (S110). The SEM image of the steel material may be read through the input device 120, the SEM image stored in the storage device 140 may be read by the identification unit 111. Further, the SEM image stored in the server or the network drive may be read into the identification unit 111 through the network connected to the communication device 150.

The program causes the identification unit 111 to identify the cross-sectional area of the crystal grains constituting the steel material from the read SEM image of the steel material (S130). In an embodiment, the program causes the mask data generation unit 112 to determine whether or not the pixels constituting the SEM image have a luminance value equal to or less than the first predetermined value (S131). The program causes the mask data generation unit 112 to set a pixel having a luminance value equal to or less than the first predetermined value to a portion to be masked (S133). Further, the program causes the mask data generation unit 112 to set the pixel having a luminance value higher than the first predetermined value to the part not to be masked (S135). The program synthesizes the portions set in this way and causes the mask data generation unit 112 to generate mask data from the SEM image (S137). The program can cause the identification unit 111 to identify the cross-sectional area of the crystal grains constituting the steel material based on the mask data (S139).

The program causes the extraction unit 113 to extract image data of the cross-sectional area of the crystal grains from the SEM image based on the cross-sectional area of the crystal grains identified by the identification unit 111 (S150). Specifically, the program causes the extraction unit 113 to subtract the mask area including the structure that becomes noise from the SEM image based on the mask data generated by the mask data generation unit 112 (S151) to extract the image data of the cross-sectional area of the crystal grains (S153).

The program causes the data conversion unit 115 to binarize the image data extracted by the extraction unit 113 (S170). Specifically, the program causes the data conversion unit 115 to binarize the image data of the cross-sectional area of the crystal grains for each pixel constituting the extracted image data of the cross-sectional area of the crystal grains with reference to the second predetermined value (S171). More specifically, the program causes the data conversion unit 115 to convert a luminance value of a portion having luminance of the second predetermined value or more (or greater than the second predetermined value) in the image data to 1 (S173), and convert a luminance value of a portion having a luminance less than the second predetermined value (or the second predetermined value or less) to 0 (S175). The program synthesizes the portions set in this way, and causes the data conversion unit 115 to generate the image data obtained by binarizing the cross-sectional area of the crystal grains from the image data of the cross-sectional area of the crystal grains (S177). As a result, the program can cause the data conversion unit 115 to identify the portion having the luminance value 1 as a structure of a carbide. The second predetermined value may be a luminance value set in advance from the observation of the SEM image of the steel material, and may be a luminance value set by the user in the actual SEM image of the steel material that is processed by the data conversion unit 115 and that the user confirmed on the display device 131. In an embodiment, an average value of the luminance of the pixel of interest and the luminance of the surrounding pixels may be set as the second predetermined value (adaptive binarization).

### Modified Example of Program for Detecting Carbide Morphology

In the above embodiment, an example in which the identification unit is caused to identify the cross-sectional area of the crystal grains constituting the steel material from the scanning electron microscope image of the steel material, the extraction unit is caused to extract the image data of the cross-sectional area of the crystal grains from the scanning electron microscope image based on the identified cross-sectional area of the crystal grains, and the data conversion unit is caused to binarize the extracted image data to determine the structure of the carbide has been described. However, in the program for detecting the carbide morphology according to the present invention, it is also possible to identify the cross-sectional area of the crystal grains constituting the steel material after binarizing the scanning electron microscope image of the steel material.

FIG. 8 to FIG. 11 are referred to. The program causes the data conversion unit 115 to read the SEM image of the steel material (S210). Since a step of reading a SEM image is the same process as that of S110 described above, a detailed explanation thereof will be omitted. The program causes the data conversion unit 115 to binarize the SEM image of the steel material (S230). The present program causes the data conversion unit 115 to binarize the SEM image of the steel material in the SEM image of the steel material with reference to a predetermined value (hereinafter, also referred to as a second predetermined value) (S231). More specifically, the program causes the data conversion unit 115 to convert the luminance value of the portion having a luminance of the second predetermined value or more (or greater than the second predetermined value) in the SEM image of the steel material to 1 (S233), and the luminance value of the portion having a luminance less than the second predetermined value (or the second predetermined value or less) to 0 (S235). By such processes, the program can cause the data conversion unit 115 to determine the portion having the luminance value 1 as a structure which may be a carbide (S239). The second predetermined value may be a luminance value set in advance from the observation of the SEM image of the steel material, or may be a luminance value set by the user in the actual SEM image of the steel material that is processed by the data conversion unit 115 and that the user confirmed on the display device 131. In an embodiment, an average value of the luminance of the pixel of interest and the luminance of the surrounding pixels may be set as the second predetermined value (adaptive binarization).

The program causes the identification unit 111 to identify the cross-sectional area of the crystal grains constituting the steel material from the image data binarized by the data conversion unit 115 (S250). In an embodiment, the program causes the mask data generation unit 112 to determine whether or not the pixels constituting the binarized image data have the luminance value equal to or less than the first predetermined value (S251). The program causes the mask data generation unit 112 to set a pixel having a luminance value equal to or less than the first predetermined value to a portion to be masked (S253). Further, the program causes the mask data generation unit 112 to set the pixel having a luminance value higher than the first predetermined value to a portion not to be masked (S255). The program causes the mask data generation unit 112 to synthesize the portions set in this way and causes the mask data generation unit 112 to generate mask data from the binarized image data (S257). The program causes the identification unit 111 to identify the cross-sectional area of the crystal grains constituting the steel material in the binarized image data based on the mask data (S259).

The program causes the extraction unit 113 to extract the image data of the cross-sectional area of the crystal grain from the binarized image data on the basis of the cross-sectional area of the crystal grain of the binarized image data identified by the identification unit 111 (S270). Specifically, the program causes the extraction unit 113 to subtract the mask area including a structure which becomes noise from the binarized image data on the basis of the mask data generated by the mask data generation unit 112 (S271) to extract the image data of the cross-sectional area of the crystal grains (S273). As a result, the program causes the extraction unit 113 to identify the cross-sectional area of the crystal grains extracted from the binarized image data as a structure of a carbide.

### Program for Detecting Carbide Morphology Using Machine Learning

In the embodiment described above, an example in which the image data of the cross-sectional area of the crystal grains is extracted from the SEM image on the basis of the mask data generated by the mask data generation unit 112 has been described. However, the program for detecting the carbide morphology according to the present invention can also be configured to extract the image data of the cross-sectional area of the crystal grains from a SEM image using machine learning.

FIG. 12 to FIG. 15 are referred to. The program causes the identification unit 111A to read the SEM image of the steel material (S310). Since a step of reading a SEM image is the same process as that of S110 described above, a detailed explanation thereof will be omitted. The program causes the identification unit 111A to identify the cross-sectional area of the crystal grains constituting the steel material from the read SEM image of the steel material (S330).

The program causes the machine learning unit 112A to train a machine learning model using a plurality of the SEM images of steel materials for learning (S331). Although the machine learning to be performed by the machine learning unit 112A may be either supervised learning, unsupervised learning, or reinforcement learning, in an embodiment, the machine learning model may be trained by supervised learning to provide cross-sectional areas of the crystal grains comprising the steel material in the SEM image to be used for learning.

In an embodiment, the program may cause the machine learning unit 112A to perform deep learning using a neural network. Further, in an embodiment, the program may cause the machine learning unit 112A to use the TWS method to perform machine learning to identify the cross-sectional areas of the crystal grains constituting the steel material. For example, the program causes the machine learning unit 112A to extract features from the SEM image using a plurality of filters, and create feature vectors for each pixel. The program trains the decision tree as the machine learning model by using the created feature vectors and creates a classifier based on the random forest method. Classification by class is executed by applying the created classifier to the SEM image (S333). Consequently, the program causes the machine learning unit 112A to identify the cross-sectional area of the crystal grains constituting the steel material (S335).

The program causes the extraction unit 113 to extract the image data of the cross-sectional area of the crystal grains from the SEM image based on the cross-sectional area of the crystal grains identified by the identification unit 111A (S150). Specifically, the program causes the extraction unit 113 to extract image data of the cross-sectional area of the crystal grains based on the cross-sectional area of the crystal grains identified by the identification unit 111A (S351).

The program causes the data conversion unit 115 to binarize image data extracted by the extraction unit 113 (S370). Specifically, the program causes the data conversion unit 115 to binarize the image data of the cross-sectional area of the crystal grains with reference to the second predetermined value for each pixel constituting the image data of the cross-sectional area of the extracted crystal grains (S371). More specifically, the program causes the data conversion unit 115 to convert a luminance value of a portion having a luminance of the second predetermined value or more (or greater than the second predetermined value) in the image data to 1 (S373), and convert a luminance value of a portion having a luminance less than the second predetermined value (or the second predetermined value or less) to 0 (S375). The program causes the data conversion unit 115 to synthesize the portions thus set, and causes the data conversion unit 115 to generate the image data obtained by binarizing the cross-sectional area of the crystal grains from the image data of the cross-sectional area of the crystal grains (S377). As a result, the program can cause the data conversion unit 115 to identify a portion having the luminance value 1 as a structure of a carbide. The second predetermined value may be a luminance value set in advance from the observation of the SEM image of the steel material, or may be a luminance value set by the user in the actual SEM image of the steel material that is processed by the data conversion unit 115 and that the user confirmed on the display device 131. In an embodiment, an average value of the luminance of the pixel of interest and the luminance of the surrounding pixels may be set as the second predetermined value (adaptive binarization).

### Modified Example of Program for Detecting Carbide Morphology Using Machine Learning

As described above, in the program for detecting the carbide morphology according to the present invention, it is also possible to identify the cross-sectional area of the crystal grains constituting the steel material after binarizing the scanning electron microscope image of the steel material. FIG. 16 to FIG. 19 are referred to. The program causes the data conversion unit 115 to read the SEM image of the steel material (S410). Since a step of reading a SEM image is the same process as that of S110 described above, a detailed explanation thereof will be omitted. The program causes the data conversion unit 115 to binarize the SEM image of the steel material (S430). The program causes the data conversion unit 115 to binarize the SEM image of the steel material in the SEM image of the steel material, based on a predetermined value (hereinafter, also referred to as a second predetermined value) (S431). More specifically, the program causes the data conversion unit 115 to convert a luminance value of a portion having a luminance of the second predetermined value or more (or greater than the second predetermined value) in the SEM image of the steel material to 1 (S433), and convert a luminance value of a portion having a luminance less than the second predetermined value (or the second predetermined value or less) to 0 (S435). By such processes, the program can cause the data conversion unit 115 to determine the portion having the luminance value 1 as a structure which may be a carbide (S439). The second predetermined value may be a luminance value set in advance from the observation of the SEM image of the steel material, and may be a luminance value set by the user in the actual SEM image of the steel material that is processed by the data conversion unit 115 and that the user confirmed on the display device 131. In an embodiment, an average value of the luminance of the pixel of interest and the luminance of the surrounding pixels may be set as the second predetermined value (adaptive binarization).

The program causes the identification unit 111A to identify the cross-sectional area of the crystal grains constituting the steel material from the binarized image data by the data conversion unit 115 (S430). The program causes the machine learning unit 112A to train a machine learning model using a plurality of binarized image data for learning (S431). Although the machine learning to be performed by the machine learning unit 112A may be either supervised learning, unsupervised learning, or reinforcement learning, in an embodiment, the machine learning model may be trained by supervised learning to provide cross-sectional areas of the crystal grains constituting the steel material in the SEM image to be used for learning.

In an embodiment, the program may cause the machine learning unit 112A to perform deep learning using a neural network. In an embodiment, the program may also cause the machine learning unit 112A to perform machine learning to identify the cross-sectional areas of the crystal grains constituting the steel material using the Trainable Weka Segmentation (TWS) method. For example, the program cause the machine learning unit 112A to extract features from the SEM image using a plurality of filters, and to create feature vectors for each pixel. The program causes the machine learning unit 112A to train a decision tree as the machine learning model and causes the machine learning unit 112A to create a classifier based on the random forest method. The program causes the machine learning unit 112A to execute classification by class by applying the created classifier to the binarized image data (S433). Consequently, the program causes the machine learning unit 112A to identify the cross-sectional area of the crystal grains constituting the steel material in the binarized image data (S435).

The program causes the extraction unit 113 to extract image data of the cross-sectional area of the crystal grain from the binarized image data on the basis of the cross-sectional area of the crystal grain of the image data binarized by the identification unit 111A (S370). Specifically, the program causes the extraction unit 113 to extract the image data of the cross-sectional area of the crystal grains from the binarized image data on the basis of the cross-sectional area of the crystal grains identified by the identification unit 111A (S351). As a result, the program causes the extraction unit 113 to identify the cross-sectional area of the crystal grains extracted from the binarized image data as a structure of a carbide.

### EXAMPLE

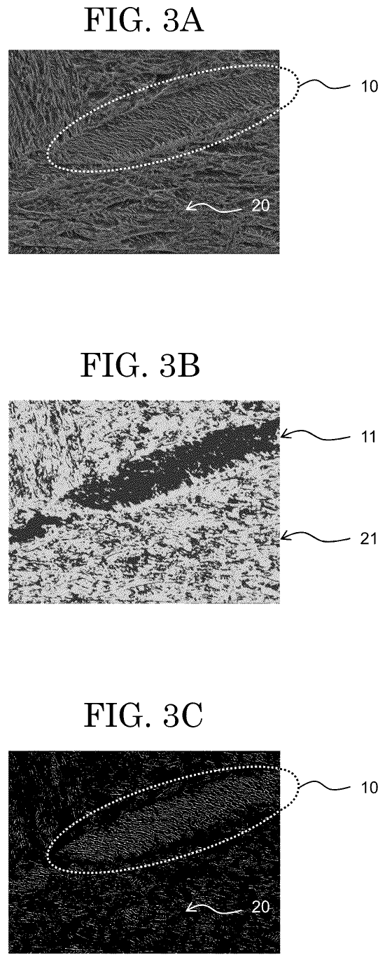

An example of carbide morphology detection using the apparatus for detecting the carbide morphology 100 described above is shown below. FIG. 3A shows the SEM image of the surface of the steel material in which a structure of a steel material has been exposed by etching. The identification unit 111 read the SEM image of FIG. 3A, and the mask data generation unit 112 generated the mask data from the SEM image. FIG. 3B is a diagram showing mask data of an example of the present invention. The extraction unit 113 subtracts the mask area including the structure which becomes noise from the SEM image on the basis of the mask data generated by the mask data generation unit 112 to extract the image data of the cross-sectional area of the crystal grains. FIG. 3C is a view of extracting a cross-sectional area of the crystal grains of an embodiment of the present invention. The cross-sectional area of the crystal grains thus extracted was binarized by the data conversion unit 115, and the structure of the carbide as shown in the right diagram of FIG. 2B could be identified.

In the embodiment and examples described above, the case where the SEM image of the steel material taken by the scanning electron microscope is used has been described. In addition to the scanning electron microscope, it is also possible to use a microscope capable of observing the crystal grains of steel, such as a transmission electron microscope (TEM), a scanning transmission electron microscope (STEM), and an atomic force microscope (AFM).

Although the embodiment of the present invention has been described above with reference to the drawings, the present invention is not limited to the above embodiment, and it is possible to appropriately change the embodiments without departing from the scope of the present invention. For example, based on the apparatus for detecting the carbide morphology of the steel material, the method for detecting the carbide morphology of the steel material, and the program for detecting the carbide morphology of the steel material of the present embodiment, any addition, deletion, or design modification of components by a person skilled in the art is included within the scope of the present invention as long as it maintains the gist of the present invention. Furthermore, the embodiments described above can be appropriately combined as long as they do not contradict each other, and the technical matters common to each embodiment are included in each embodiment without explicit description.

It is to be understood that other working-effects different from those brought about by the aspects of each of the above-mentioned embodiments, and those that are clear from the description in this specification or that can be easily predicted by a person skilled in the art are naturally brought about by the present invention.

An embodiment of the present invention provides a detection apparatus capable of accurately converting a carbide morphology in a steel material into digital data. Alternatively, an embodiment of the present invention provides a detection method capable of accurately converting a carbide morphology in a steel material into digital data. Alternatively, an embodiment of the present invention provides a detection program capable of accurately converting a carbide morphology in a steel material into digital data.

What is claimed is:

1. An apparatus for detecting a carbide morphology comprising:
an identification unit for identifying a cross-sectional area of a crystal grain constituting a steel material in a microscope image of the steel material;
an extraction unit for extracting image data of the cross-sectional area of the crystal grain from the microscope image based on the identified cross-sectional area of the crystal grain; and
a data conversion unit for binarizing the extracted image data.

2. The apparatus for detecting the carbide morphology according to claim 1, wherein
the identification unit includes a mask data generation unit for producing mask data from the microscope image of the steel material or the binarized image data,
the mask data generation unit sets a portion in the microscope image or the binarized image data having a luminance value equal to or less than a first predetermined value as a portion to be masked to generate the mask data, and
the identification unit identifies the cross-sectional area of the crystal grain constituting the steel material based on the mask data.

3. An apparatus for detecting a carbide morphology comprising:
a data conversion unit for binarizing image data of a microscope image of a steel material;
an identification unit for identifying a cross-sectional area of a crystal grain constituting the steel material in the binarized image data; and
an extraction unit for extracting image data of the cross-sectional area of the crystal grain from the binarized image data based on the identified cross-sectional area of the crystal grain.

4. The apparatus for detecting the carbide morphology according to claim 3, wherein
the identification unit includes a mask data generation unit for producing mask data from the microscope image of the steel material or the binarized image data,
the mask data generation unit sets a portion in the microscope image or the binarized image data having a luminance value equal to or less than a first predetermined value as a portion to be masked to generate the mask data, and
the identification unit identifies the cross-sectional area of the crystal grain constituting the steel material based on the mask data.

5. A method for detecting a carbide morphology comprising:
using an apparatus for detecting carbide morphology including an identification unit, an extraction unit, and a data conversion unit;
identifying a cross-sectional area of a crystal grain constituting a steel material in a microscope image of the steel material by the identification unit;
extracting image data of the cross-sectional area of the crystal grain from the microscope image based on the identified cross-sectional area of the crystal grain by the extraction unit; and
binarizing the extracted image data by the data conversion unit to determine a structure of a carbide.

6. The method for detecting the carbide morphology according to claim 5, wherein
the identification unit includes a mask data generation unit,
the mask data generation unit sets a portion in the microscope image or the binarized image data having a luminance value equal to or less than a first predetermined value as a portion to be masked to generate mask data, and
the identification unit identifies the cross-sectional area of the crystal grain constituting the steel material based on the mask data.

7. The method for detecting the carbide morphology according to claim 5, wherein
the identification unit includes a machine learning unit,
the machine learning unit trains a machine learning model using a plurality of microscopic images of the steel material for learning or a plurality of binarized image data for learning, and
the identification unit inputs the microscope image of the steel material or the binarized image data to the trained machine learning model to identify the cross-sectional area of the crystal grain constituting the steel material.

8. The method for detecting the carbide morphology according to claim 5, wherein
the extraction unit extracts image data of the cross-sectional area of the crystal grain from the microscope image or the binarized image data.

9. The method for detecting the carbide morphology according to claim 5, wherein
the data conversion unit binarizes the image data of the cross-sectional area in the image data of the cross-sectional area of the crystal grain or the microscope image based on a second predetermined value.

10. A method for detecting a carbide morphology comprising:
using an apparatus for detecting carbide morphology including an identification unit, an extraction unit, and a data conversion unit;
binarizing image data of a microscope image of a steel material by the data conversion unit;
identifying a cross-sectional area of a crystal grain constituting the steel material in the binarized image data by the identification unit; and
extracting image data of the cross-sectional area of the crystal grain from the binarized image data based on the identified cross-sectional area of the crystal grain by the extraction unit to determine a structure of a carbide.

11. The method for detecting the carbide morphology according to claim 10, wherein
the identification unit includes a mask data generation unit,
the mask data generation unit sets a portion in the microscope image or the binarized image data having a luminance value equal to or less than a first predetermined value as a portion to be masked to generate mask data, and
the identification unit identifies the cross-sectional area of the crystal grain constituting the steel material based on the mask data.

12. The method for detecting a carbide morphology according to claim 10, wherein
the identification unit includes a machine learning unit,
the machine learning unit trains a machine learning model using a plurality of microscopic images of the steel material for learning or a plurality of binarized image data for learning, and
the identification unit inputs the microscope image of the steel material or the binarized image data to the trained machine learning model to identify the cross-sectional area of the crystal grain constituting the steel material.

13. The method for detecting the carbide morphology according to claim 10, wherein
the extraction unit extracts image data of the cross-sectional area of the crystal grain from the microscope image or the binarized image data.

14. The method for detecting the carbide morphology according to claim 10, wherein
the data conversion unit binarizes the image data of the cross-sectional area in the image data of the cross-sectional area of the crystal grain or the microscope image based on a second predetermined value.

15. A storage media storing a program for detecting a carbide morphology, the program comprising:
causing a computer to identify a cross-sectional area of a crystal grain constituting a steel material in a microscope image of a steel material;
causing the computer to extract image data of the cross-sectional area from the microscope image based on the identified cross-sectional area of the crystal grain; and
causing the computer to binarize the extracted image data to determine a structure of the carbide.

16. The storage media storing the program for detecting the carbide morphology according to claim 15, the program further comprising:
causing the computer to set a portion in the microscope image or the binarized image data having a luminance value equal to or less than a first predetermined value as a portion to be masked to generate mask data, and
causing the computer to identify the cross-sectional area of the crystal grain constituting the steel material based on the mask data.

17. A storage media storing a program for detecting a carbide morphology, the program comprising:
causing a computer to binarize image data of a microscope image of a steel material;
causing the computer to identify a cross-sectional area of a crystal grain constituting the steel material in the binarized image data; and
causing the computer to extract image data of the cross-sectional area from the binarized image data based on the identified cross-sectional area of the crystal grain to determine a structure of the carbide.

18. The storage media storing the program for detecting the carbide morphology according to claim 17, the program further comprising:
causing the computer to set a portion in the microscope image or the binarized image data having a luminance value equal to or less than a first predetermined value as a portion to be masked to generate mask data, and
causing the computer to identify the cross-sectional area of the crystal grain constituting the steel material based on the mask data.
